(19) United States
(12) Patent Application Publication
(10) Pub. No.: US 2007/0037057 A1
(43) Pub. Date: Feb. 15, 2007

(54) Non printed small volume in vitro analyte sensor and methods

(76) Inventor: Joel S. Douglas, Groton, CT (US)

Correspondence Address: Wayne R. Grohs;MysticMD Inc., 66 Neptune Drive, Groton, CT, 06340, US

(21) Appl. No.: 11/502,811

(22) Filed: Aug. 10, 2006

Related U.S. Application Data
(60) Provisional application No. 60/707,863, filed on Aug. 12, 2005.

(51) Int. Cl. H01M 4/58

(52) U.S. Cl. 429/231.8

(57) ABSTRACT

An electrically conductive coating is disclosed. According to one embodiment of the present invention, the coating includes a plurality of single-wall or multi-walled Carbon nanotubes having a diameter less than 20 nanometers. The disclosed coating demonstrates excellent conductivity and smooth surface morphology. Methods of preparing the coating as well as methods of its use are also disclosed herein.

### CROSS REFERENCE TO RELATED APPLICATIONS

This application claims priority to U.S. Provisional Patent Application Ser. No. 60/707,863, filed Aug. 12, 2005, the contents of which are incorporated herein by reference in their entirety.

### FIELD OF THE INVENTION

This invention relates in general to analytical sensors for the detection of bioanalytes in a small volume sample, and methods of making and using the sensors. More particularly, the present invention relates to an electrochemical test device suitable for determining the presence or concentration of chemical and biochemical components (analytes) in aqueous fluid samples and body fluids such as whole blood or interstitial fluid. Additionally, this invention relates to a method of using such test devices for determining the presence or concentration of an analyte and to processes for preparing such a test

### BACKGROUND OF THE INVENTION

Medical studies have demonstrated that the incidence of serious complications resulting from diabetes, such as vision loss and kidney malfunction, can be significantly reduced by careful control of blood glucose levels. As a result, millions of diabetics use glucose testing devices daily to monitor their blood glucose concentrations. Additionally, a wide variety of other blood testing devices are used to determine the presence or concentration of other analytes, such as alcohol or cholesterol, in aqueous samples, such as blood.

Such blood testing devices typically employ either a dry chemistry reagent system or an electrochemical method to test for the analyte in the fluid sample. In recent years, electrochemical testing systems have become increasingly popular due to their small size and ease of use. Such electrochemical testing systems typically use electrochemistry to create an electrical signal that correlates to the concentration of the analyte in the aqueous sample.

Numerous electrochemical testing systems and related methods are known in the art. For example, European Patent Publication No. 0 255 291 B1, to Birch et al., describes methods and an apparatus for making electrochemical measurements, in particular but not exclusively for the purpose of carrying out microchemical testing on small liquid samples of biological, e.g. of clinical, origin.

European Patent Publication No. 0 351 891 B1, to Hill et al., teaches a method of making an electrochemical sensor by printing. The sensor is used to detect, measure or monitor a given dissolved substrate in a mixture of dissolved substrates, most specifically glucose in body fluid.

U.S. Pat. No. 5,391,250, to Cheney II et al., teaches a method of fabricating thin film electrochemical sensors for use in measuring subcutaneous or transdermal glucose. Fabrication of the sensors comprises placing a thin film base layer of insulating material onto a rigid substrate. Conductor elements for the sensors are formed on the base layer using contact mask photolithography and a thin film cover layer.

U.S. Pat. No. 5,437,999, to Diebold et al., teaches a method of fabricating thin film electrochemical devices that are suitable for biological applications using photolithography to define the electrode areas. The disclosures of each of the above patent specifications are incorporated herein by reference in their entirety.

An excellent reference on materials and process for fabricating electronic components is Charles A. Harper, Handbook of Materials and Processes for Electronics, 1984, Lybrary of Congress card number 76-95803. It provides detail process information on thick film, thin film and photo resist processes.

Existing electrochemical testing systems, however, have certain limitations from the perspective of the manufacturer. For example, some electrochemical testing systems are difficult or costly to manufacture. As a result, such devices are too expensive to be used on a daily basis by, for example, by people with diabetes. Other electrochemical testing systems are not sufficiently accurate to detect certain analytes at very low concentrations or to give reliable measurements of the analyte's concentration. Additionally, many electrochemical devices are too large to be easily carried by those needing to test their blood on a regular basis throughout the day. Thus, a need exists for improved electrochemical test devices.

The conductive materials formed by the wet processes that are currently used in electrochemical applications need to have repeatable surface areas, be repeatable in their printed definition, and have the ability to alloy with catalysis and other chemicals. The electrically conductive ink and coatings that are known in the art address some of the attributes needed by the applications but they do not provide a repeatable surface area due to their resulting rough surface morphology and non repeatable surface area due to the larger particles used to form the conductive matrix. The ductility and flexibility of these materials is also an issue because the large particles and the associated matrix do not adhere to the substrates sufficiently to provide a good bond and are easily cracked when bent. In general, when such conductive coatings are formed on an electrical insulating non conductive substrate using a wet process a conductive film is formed that has a rough surface morphology and is prone to cracking. When used as an electrochemical process, the large conductive particles used in existing coatings or inks result in a non repeatable rough surface area. This non reproducible surface area is problematic for electrochemical reactions which are surface area sensitive and the large particles used in the coatings and inks are responsible for these problems when using these materials. The large particles result in an irregular surface morphology because of the size of the particles used to create the conductive in the ink or coating and they also cause the boundary to be irregular because to insure that the large particles a printed properly a large mesh screen on the order of 300 to 200 meshes per inch must be used.

The dry process forms a better surface morphology and bond to the substrate than the wet processes but it has significant issues due to cost and process ability and are easily cracked when bent. In the dry process, Physical Vapor Deposition (PVD) (e.g. sputtering, ion plating, vacuum deposition, etc.) or Chemical Vapor Deposition (CVD) (e.g. organometallic CVD, Metal oxideCVD,) is used to form a conductive transparent coating of a metal oxide type that has a smooth surface morphology, e.g., tin-indium mixed oxide (ITO), antimony-tin mixed oxide (ATO), fluorine-doped tin oxide (FTO), aluminum-doped zinc oxide (FZO), zinc oxide (ZNO). While the vacuum process creates a smooth surface morphology they have the added drawback of irregular edges and high cost. When material made from these methods are used the material is usually etched which creates irregular edges and results in an inconsistent strip surface area from strip to strip. Also the process is very expensive because of the vacuum chamber process. The coatings formed this way are also subject to failure by cracking when bent.

In the wet process, a conductive coating composition is formed using an electrically conductive powder, e.g., one of the above-described mixed oxides, amorphous carbon, silver powder, and other metals combined with a binder which forms dispersion. The dry process produces a conductive coating that has smooth surface morphology and good conductivity. However, the dry process requires a complicated apparatus having a vacuum system and deposition process and does not permit the real time marking of a substrate because of the need to be done in a vacuum. This is a very expensive process. Also the substrate has to be morphologically very smooth and clean before the deposition can be carried out. This restricts the type of substrate that can be used for coating. Another problem with both the CVD and PVD depositions are that they are carried out at high temperatures and so the substrate needs to be a material with high melting point. Equipment from manufacturers such as CVD Equipment Corporation, Ionbond equipment or Ulvac can be used to produce roll coated depositions of conductive film products using a dry process. An excellent reference on materials and process for fabricating electronic components is Charles A. Harper, Handbook of Materials and Processes for Electronics, 1984, Library of Congress card number 76-95803. It provides detailed process information on thick conductive ink and coating, thin conductive ink and coating and photo resist processes. As described in the textbook Handbook of Materials and Processes for Electronics, dry process fabrication of electrically conductive inks and coatings is difficult to apply to a continuous or large substrate such as in a large converting process because of the cost of forming the vacuum chambers.

The existing wet process requires a relatively simple apparatus, has high productivity, and is easy to apply to a continuous or large substrate. In addition it can be scaled up and is compatible with traditional converting coating and printing processes such as those found in the text book Flexography, Principles and Practices, Library of Congress Card No. 80-69506.

A typical commercially available ink product is the conductive dispersion such as Acheson Electrodag 427 Antimony Tin Oxide (ATO) dispersion. This dispersion has a high solids concentration that creates a rougher surface texture to achieve higher conductivity due to the need to increase the concentration of conductive particles so that they provide a conductive path through the matrix of the coating, which also results in the rough surface morphology and a thick coating thickness. The thick coating thickness that is usually 0.0005 nches or thicker is needed to achieve adequate conductivity. This also results in a less ductile film that is prone to cracking. Also a common problem with these high solids dispersion is their adhesion to the substrate that they are applied to is not strong. A solution to these problems is needed to increase the usefulness of conductive inks and coatings.

The discovery of carbon nanotubes was a significant discovery and improvement in the creation of conductive inks and coatings. Essentially single graphite layers wrapped into tubes, carbon nanotubes are either single wall (SWNT), double wall (DWNT) or multi wall (MWNT) nanotubes wrapped in several concentric layers. (B. I. Yakobson and R. E. Smalley, “Fullerene Nanotubes: C.sub. 1,000,000 and Beyond”, American Scientist v. 85, July-August 1997.) Although only first widely reported in 1991, (Phillip Ball, “Through the Nanotube”, New Scientist, Jul. 6, 1996, p. 28-31.) carbon nanotubes are now readily synthesized in gram quantities in laboratories all over the world and commercially available from such companies as Mitsui & Co. or Helix Material Solutions, Inc. The tubes have good intrinsic electrical and thermal conductivity on an average and have been used to form conductive materials.

U.S. Pat. No. 5,853,877, the disclosure of which is incorporated herein by reference in its entirety, relates to the use of chemically modified multi-walled nanotubes (MWNT). The coating and conductive inks and coatings disclosed in U.S. Pat. No. 5,853,877 are optically transparent and have a smooth surface morphology when compared to thick film applications and formed as a very thin layer. However, the thin layer embodiments have limited conductive properties. As the thickness of the conductive ink and coatings increases to greater than about 5 um to increase the conductive property, the conductive ink and coatings lose their smooth surface morphologies when compared to polyester substrate which has a surface roughness of approximately 3500 nm using an Atomic force microscopy (AFM).

The loss of these properties limits the usefulness of the resulting conductive coatings for test strips made in accordance with the invention because it requires good, good adhesion, ductility or smooth surface morphology.

U.S. Pat. No. 5,853,877 also relates to conductive ink and coatings that are formed with and without binders. The conductive ink and coatings include binders with a very high nanotube concentration and are extremely thin in order to maintain the optical properties desired. For example, the patent discloses a conductive ink and coating with 40% wt MWNT loading to get good BSD conductivities. However the clarity and smoothness of the surface morphology is limited by the high percentage of MWNT in the conductive ink and coating which makes the coating appear grey to black and the surface roughness is greater than 3300 nm using an Atomic force microscopy (AFM).

U.S. Pat. No. 5,908,585, the disclosure of which is incorporated herein by reference in its entirety, relates to the use of two conductive additives, both MWNT and an electrically conductive metal oxide powder and the surface roughness is also greater than 3300 nm using an Atomic force microscopy (AFM).

U.S. Pat. No. 6,783,746, the disclosure of which is incorporated herein by reference in its entirety, relates to methods of preparing stable dispersions of nanotubes are described and surfactants/dispersants are identified which can disperse carbon nanotubes in aqueous and petroleum liquid medium.

U.S. Pat. No. 6,878,361, the disclosure of which is incorporated herein by reference in its entirety, relates to methods of producing stable dispersions of single-walled carbon nanotube structures in solutions are achieved utilizing dispersal agents. The dispersal agents are effective in substantially solubilizing and dispersing single-walled carbon nanotube structures in aqueous solutions by coating the structures and increasing the surface interaction between the structures and water.

U.S. Pat. No. 7,060,241 relates to conductive inks and coatings that arc formed with carbon nanohibes with a diameter of 3.5 nm or less and has high transparency and low haze.

### SUMMARY OF THE INVENTION

The present novel application relates to the creation of a test strip which can be formed by die cutting and forming without utilizing expensive printing or vacuum based processes and creates a very fine surface morphology which makes the sensors made from the invention repeatable and accurate both important attributes when manufacturing thousands of test strips per day. The test strip design of the invention also takes advantage of the ductile nature of the conductive material formed by the invention. Because the coatings are ductile the electrodes can be bent which cannot be done with the brittle coatings of the prior art.

The invention provides methods to improve the surface morphology, adhesion, ductility and electrical conductivity of a film made from dispersions of carbon nanotubes, conductive organic and inorganic materials and metals that can be used to create a test strip that does not require costly printing to achieve accuracies and can be made with the ductile inks of the invention. The invention is especially suited for use with electrochemical applications where a smooth surface morphology, ductility and high bond strength provides advantages for reduce cost and more consistent and accurate results. The increase in ductility and adhesion are related because with strong adhesion and good ductility the coating or ink does not crack and the adhesion prevents the material from delaminating from the substrate and cracking. The surface morphology of the substrate which the coating is applied to forms the base surface morphology which when polyester is used as the substrate can be as low as 80 nm from high to low points on the substrate.

The present invention utilizes Conductive materials utilizing made from conductive inks containing carbon nanotubes, carbon, Platinum, ITO, ZNO, ATO, silver, silver chloride, gold and other conductive oxides or metals, applied with conventional converting manufacturing techniques to provide an electrochemical test device suitable for determining the presence or concentration of analytes in aqueous fluid samples. By using conductive materials applied uniformly to the electrode bearing substrate eliminates the costly printing processes used by current test strip manufactures and the errors in test strip production introduced into a test strip by these processes. By coating the substrate uniformly the electrochemical test devices does not require the costly electrode printing step and the conductive inks of the invention result in a very smooth surface morphology test strip that has excellent electrochemical performance and has well-defined reproducible electrode areas that can be manufactured economically by continuous converting techniques such as coating, die punching and assembly.

In particular, the test devices of this invention have very uniform surface areas which reduce the variability of the electrochemical test. In this regard, it has been found that the surface area of the electrodes and the accuracy of applying the reagent influence the production of an accurate test. If the surface area is not consistent from test to test then each of the test devices can be individually calibrated or sorted to insure accurate readings. The test devices of the present invention permit highly accurate electrochemical analyte measurements to be performed on very small aqueous fluid samples without the need for individual calibration of each test device. The present inventions provide for the accurate reproduction of the test devices by using controlled deposition methods, such roll coating, slot coating, slide coating, flexo and other commercial continuous converting techniques to form the electrodes with consistent size and surface morphology from device to device in continuous production. These devices can also be readily manufactured due to the lower cost and the flexible nature of the Conductive materials which facilitates production by continuous roll processing versus the step and repeat printing methods currently employed. The ability to use continuous processing to fabricate the sensor device, such as utilizing continuous roll coating, results in high volume manufacturing capability and substantial cost reductions over the step and repeat processes. Additionally, the nature of the conductor electrodes and the design of the test strip, constructed and used according to this invention, eliminates problems found in prior test devices which utilize conventional materials and the printing of individual test strip electrodes. This electrode print step creates the opportunity for one or more of the following errors to enter into the process: (1) the electrodes can be formed with a different surface morphology from strip to strip, (2) the electrode are formed with a differing surface area (geometry) from strip to strip due to the current screen printing errors or vacuum deposition and etching errors, and (3) the test strip electrodes are created with alignment errors. As a result of any of these errors, the current test strip production systems require expensive equipment and/or expensive calibration steps and/or sorting during manufacturing to insure like formed test strips are matched together. The conductive materials of the present invention can be formed from a variety of conductive carbon nanotubes, metals and oxide mixtures and dispersions as described in co pending applications “Strip Electrode with conductive nano tube printing” (Serial No. 2005/018633), “Coatings comprising of carbon nanotubes” (Serial No. WO 2005/119772), and “Creation of carbon nanotube suspension formulation” (U.S. Provisional Application No. 60/708,510). The present invention die cuts the electrodes from the coated material. The electrodes are formed using die cutting, forming and assembly techniques currently standard on modem converting equipment. The invention can be configured as either a two or three electrode configuration. The description of the invention will focus on a two electrode test strip but can easily be converted into a three electrode test strip. The first substrate is converted and coated with a flexible conductive material formed from, carbon nanotubes, carbon, oxides, or metals. The first layer is preferably coated with a carbon nanotube coating as found in co pending application “Strip Electrode with Conductive Nano Tube Printing” and/or conductive coatings such as described in U.S. Patent Application Publication No. 2002/0143094, “Polymer Nanocomposites and Methods of Preparation” to Conroy et al., U.S. Patent Application Publication No. 2003/0008123, “Nanocomposite Dielectrics” to Glatkowski et al., U.S. Patent Application Publication No. 2003/0122111, “Coatings Comprising Carbon Nanotubes and Methods for Forming Same” to Glatkowski et al., copending U.S. Patent Application No. 60/708,510 “Coatings comprising carbon nanotubes” and copending application “Coatings comprising Carbon Nanotubes and Antimony-Tin Oxide,” the contents of all of the foregoing being incorporated by reference in their entireties. The coatings made from the referenced patents and applications can be made from single wall or multi wall carbon nanotubes preferably sized to be less than 20 nm and greater than 0.1 nm in outer dimension size. Additionally conductive dispersions such as Acheson Electrodag 427 Antimony Tin Oxide (ATO) ink can be alloyed with either single wall or multi wall carbon nanotubes preferably sized to be greater than 3.5 nm and less than 20 nm in size to achieve a coating that allows for improved surface which permits the formation of surface texture less than 0.33 microns and improved repeatability of the edges of the electrode shape. The carbon nano tubes may be mixed uniformly into the Acheson Electrodag 427 such that the percent by weight is between 0.5 to 10%. However, any conductive material that has a polymer base could be used as the base material for invention. The polymeric materials may be selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, Poly(methylmethacrylate), polynucleotides and mixtures thereof, or ceramic hybrid polymers, Ethylene Glycol Monobutyl Ether Acetate, phosphine oxides and chalcogenides.

Preferably the carbon nano tubes are added such that they make up 3% by weight of the mixture. Additionally platinum nano particles can be added and mixed uniformly to the coating such that the percent by weight is between 0.5 to 10%. Preferably the nano size platinum are added such that they make up 4% by weight of the mixture. A nano particle is a particle of material that is less than 100 nano meters in diameter and is formed from a metal, metal oxide, organic conductive material, or conventional conductive particles such as conductive inorganic materials. The conductive organic materials may comprise particles containing fullerenes, spherical fullerenes (buckyballs), carbon black, graphite fibers, graphite particles, or combinations and mixtures thereof. Conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, amorphous carbon, or combinations or mixtures thereof. Preferred conductive materials include, but are not limited to, tin-indium mixed oxide, antimony-tin mixed oxide, fluorine-doped tin oxide, aluminum-doped zinc oxide and combinations. Each of the above references is incorporated herein by reference in its entirety. Additionally, the carbon nanotubes can be applied to a layer of traditional conductive material which has been applied in a thin first layer approximately less than 0.005 inches thick and the carbon nanotube dispersion applied over the first layer so as to fill in the rough surfaces and also improve the conductivity of the composite layer. This second application of carbon nanotubes may also be alloyed with catalysis such as platinum to form a platinum electrochemical strip. The materials formed by the invention have two unique features. The first is that they create a smooth surface morphology which can be formed into well defined electrodes if required and the second feature is that the coating is ductile and does not crack when bent or folded. This second feature provides a unique opportunity to reduce the cost of making a test strip by allowing the strip to be formed with the proximal electrodes opposing each other forming the electrochemical reaction area as shown in FIG. 1 and the distal contacts which allow the test strip to be removable in communication with a electronics system or meter to be formed by bending the distal end of the electrode material to form outwardly opposing contacts for the communicating with the electronics of the test system as shown in FIG. 1. Existing materials used in the manufacture of test strips do not allow this bending to form the strip contacts because they are brittle. Examples of materials used in current test strip manufacturing include thick films made from conductive materials and polymers such as wet process printed dispersions made from amorphous carbon, silver, silver/silver-chloride or the various dry process coatings made by sputtering or vacuum deposition metals. These materials are brittle for different reasons. The wet process materials achieve there conductivity by creating a dispersion that has a high solids content so that the conductive particles touch each other so that they are in communication with one another which allows the formation of a conductive pathway. The high concentration of solids results in a brittle coating when dried and a rough surface morphology resulting from the high solids content. The dry process forms conductive electrodes by first sputtering or vacuum depositing the metal of organic conductive materials onto a carrier. Etching or other removal processes then form the electrodes. This results in an electrode with an irregular outline due to the etching process and is brittle and can be easily cracked if the strip is bent.

Dry electrochemical test devices fall into two primary configurations. The first configuration utilizes two electrodes, i.e., a working electrode and a counter electrode. The second configuration utilizes three electrodes, i.e., a working electrode, a counter electrode and a reference electrode, The use of the reference electrode and a reference material provides a fixed reference for the test. Test devices of the present invention are well suited for a two electrode system; however, a contact mask could be employed during manufacturing to create a surface with two electrodes.

Accordingly, in one of its aspects, the present invention provides an electrochemical test device for determining the presence or concentration of an analyte in an aqueous fluid sample, said electrochemical test device comprising:

(a) a non-conductive substrate;

(b) a working electrode comprising an Conductive materials affixed to the non-conductive surface of a side of the electrode, the working electrode having an first electrode area affixed to a non conductive substrate, a first lead formed from each substrates and a reaction zone;

(c) a counter electrode comprising a Conductive material affixed to the opposite non-conductive surface of a non conductive substrate, the counter electrode having an second electrode area, a second lead and a second contact pad; and

(d) a reagent capable of reacting with the analyte to produce a measurable change which can be measured by either coulometry, amperometry, or potentiometry and can be correlated to the concentration of the analyte in the fluid sample, the reagent being applied onto the electrode surface.

In another embodiment of this invention, the test device further comprises a reference electrode comprising a conductive material affixed to the non-conductive surface, the reference electrode having an electrode area, a lead, and a contact pad, and wherein at least a portion of the electrode area is overlaid with a reference material. Preferably, the reference material is a silver/silver chloride layer, a mercury/mercury chloride layer or a platinum/hydrogen material. This electrode could be either the counter electrode or an independent third electrode.

In a preferred embodiment of this invention, the test device further comprises an adhesive separator lhal is used as a spacer for the conductive leads and can contain a vent and a channel for capturing the sample.

Preferably, the conductive material used in this invention is conductive carbon nano tube based dispersion. However, a conductive material with good ductility can be made with nano size carbon, gold, silver or other conductor materials which do not interfere with the electrochemistry of the reagent system. The conductive materials can be applied by using various techniques including sputtering, evaporation, roll coating, vapor phase deposition or other deposition techniques to form a conductive layer on test strip surface. However, wet application by spray coating is the preferred method of applying the dispersion. The surface texture of the conductive materials is preferably less than 13 micro inches or 0.33 microns and the cured conductive layer must be ductile so as to allow the electrode to be bent to form the electronic connection contacts. However, rougher textures can be used depending on the accuracy of the desired test device.

Any of the coatings or inks made from the dispersion of the invention also results in improved electrical conductivity with surface resistance in the range of less than approximately 10⁶ ohms/square per 1 mm square area. This allows the electrons generated from the reaction to be transferred unheeded so that the reaction can be measured by either coulometry, amperometry, or potentiometry. Accordingly, in a preferred embodiment, the conductive coating or ink has a surface resistance in the range of less than about 10,000 ohms/square per 1 mm square area. Preferably, the conductive ink or coating has a surface resistance in the range of about 10-10,000 ohms/square per 1 mm square area. Preferably, the conductive ink or coating has a surface resistance in the range of about 100-10,000 ohms/square per 1 mm square area. Preferably, the conductive coating or ink has a surface resistance in the range of less than about 1000 ohms/square per 1 mm square area. Preferably, the conductive ink or coating has a surface resistance in the range of less than about 100 ohms/square per 1 mm square area. Preferably, the conductive ink or coating has a surface resistance in the range of about 10-100 ohms/square per 1 mm square area.

The conductive inks and coatings also have volume resistances, as defined in ASTM D4496-87 and ASTM D257-99, in the range of about 100 ohms-cm to 10×10⁶ ohms-cm.

The reagent employed in the electrochemical test device is typically selected based on the analyte to be tested and the desired detection limits. The reagent preferably comprises an enzyme and a redox mediator. When the analyte to be detected or measured is glucose, the enzyme is preferably glucose oxidase and the redox mediator is potassium ferrocyanide. However, a preferred embodiment can be electrodes made from silver/silver chloride and the working electrode from Platinum and carbon such as carbon nanotubes.

The electrochemical test device of the present invention is used to determine the presence or concentration of an analyte in an aqueous fluid sample. Because the conductive materials are conductive the die cut electrodes are formed such that they can be folded out so as to form contacts on the outer top and bottom of the test strip. Accordingly, in one of its method aspects, the present invention provides a method for determining the presence or concentration of an analyte in an aqueous fluid sample. The method comprises:

(a) providing an electrochemical test device comprising: (i) two or more non conductive substrates; (ii) a working electrode comprising a conductive material affixed to the surface, the working electrode having an first electrode area, a first lead and a first contact pad area all formed on one substrate; (iii) a counter electrode comprising a conductive material affixed to the non-conductive surface, the counter electrode having a second electrode area, a second lead, and a second contact pad formed on a separate substrate; and (iv) a reagent capable of reacting with the analyte to produce a measurable change in potential which can be correlated to the concentration of the analyte in the fluid sample, the reagent being applied onto the working electrode, and the distal end forming the two distinct electrode contacts due to the flexible nature of the material by bending the material so that the ends form surfaces at least 30 degrees difference than the plane of the reactive surface;

(b) inserting the electrochemical test device such that the opposing contacts make contact with the meter contacts and form an electrical circuit;

(c) applying a sample of an aqueous fluid to the area of the working electrode; and

(d) reading the meter device to determine the presence or concentration of the analyte in the fluid sample.

In another embodiment, the test device employed in this method further comprises a reference electrode comprising a Conductive material affixed to the counter electrode surface, said reference electrode having a third electrode area, a third lead, and a third contact pad, and wherein at least a portion of the third electrode area is overlaid with a reference material.

Preferably, the reference material is a silver/silver chloride layer, a mercury/mercury chloride layer, or a platinum/hydrogen material. Silver/silver chloride is a particularly preferred reference material. The separation of the counter electrode conductive path and reference electrode is accomplished by coating the two materials side by side on the reference electrode substrate with a gap between the two materials so that the electrodes are formed on the same surface.

Preferably, the conductive electrode is selected from carbon nanotube coating as found in application U.S. Patent Application 2002/0143094, “Polymer Nanocomposites and Methods of Preparation” to Conroy et al., U.S. Patent Application No. 2003/0122111, “Coatings Comprising Carbon Nanotubes and Methods for Forming Same” to Glatkowski et al., copending PCT patent application Serial No. WO 2005/119772 “Coatings comprising carbon nanotubes” all of which are herein incorporated by reference in their entireties.

The invention creates conductive inks and coatings made from dispersions that result in a very smooth surface morphology after they are applied to a substrate and cured. The curing is achieved with the application of heat over time. They also provide a very ductile conductive coating which is resistant to cracking when bent. This permits the formation of the cured conductive inks and coatings having surface textures less than 2500 nm using an Atomic force microscopy (AFM) which are formed from nano size particles and produce smooth coatings and inks. The surface morphology of the substrate which the coating is applied to forms the base surface morphology which when polyester is used as the substrate can be as low as 80 nm from high to low points on the substrate. Therefore the total surface roughness for an application on polyester could be 2580 nm when accounting for the initial roughness of the polyester substrate. The carbon nanotubes form ropes or chains that provide hinge points that make the coating very ductile. These ropes will bind to each other or to other conductive materials integrated into the inks or coatings. The inks and coatings are formed from a conductive carbon nanotube dispersion which includes as part of the formulation carbon nanotubes, carbon nanotubes and platinum, amorphous carbon, carbon nanotubes/antimony tin oxide, carbon nanotubes/platinum, amorphous carbon, carbon nanotubes and platinum, or carbon nanotubes/silver or carbon nanotubes/silver-chloride carbon nanotubes and platinum, metal oxides and oxides. These dispersions as part of a conductive ink, dye, or coating when applied to a non conductive surface and cured allow the production of a ductile ink with a very repeatable surface morphology that is conductive electrically and have a very smooth surface morphology. The alloying of the coating with carbon nanotubes and solvents creates a boundary layer between the substrate and the other components of the coating such that the overall coating adheres better to the substrate and the carbon nanotubes provide a path for conducting the electrical energy between the other conductive materials in the coating or ink. The dispersions of the invention form conductive inks and coatings with a differential surface morphology roughness less than 2500 nano meters when compared to the base substrate such as polyester which has a surface roughness as low as 80 nm from high to low points on the substrate. The 2500 nano meter surface roughness is significantly smoother than current printed ink technologies which are designed as dispersions of finely divided graphite, silver, or silver chloride particles in a thermoplastic resin and contain solids in the range of 20% to 60%. These particles tend to be at least 100 microns to 10 microns in diameter and result in a surface roughness in the 50,000 nanometer range. The carbon nanotube conductive inks formed from dispersions of the invention have the same conductive capacity and have solids contents of 0.0001-10%. The carbon nanotube particle size is less than 20 nanometers for the carbon nanotubes portion of the dispersion. Compared to conventional inks, this is significantly smaller than the 10 micron particle, the surface roughness is at least 10 times smoother, and the solid content is between 6 and 20 times less.

The coatings, inks and dyes made can be made from dispersions of single wall or multi wall carbon nanotubes preferably sized to be less than 20 nm and greater than 0.5 nm in outer dimension size. Additionally, conductive dispersion such as Acheson Electrodag PF 427 Antimony Tin Oxide (ATO) ink can be alloyed with either single wall or multi wall carbon nanotubes preferably sized to be greater than 0.5 nm and less than 20 nm in outer dimension size there by increasing their conductivity, improving the surface morphology, ductility and improving adhesion to the substrate. However other polymeric materials containing polymers selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, Poly(methylmethacrylate), polynucleotides and mixtures thereof, or ceramic hybrid polymers, Ethylene Glycol Monobutyl Ether Acetate, phosphine oxides and chalcogenides can be used. The conductive materials used as fillers for these polymers can be selected from materials such as tin-indium mixed oxide (ITO), antimony-tin mixed oxide (ATO), fluorine-doped tin oxide (FTO), aluminum-doped zinc oxide (FZO), zinc oxide (ZnO) layer, amorphous carbon, graphite, silver, platinum, other metals, various oxides or a doped oxide layer, or a hard coat such as a silicon coat, or provide UV absorbance, such as a ZnO layer. The increase in ductility and adhesion are related because with strong adhesion and good ductility the coating or ink does not crack and the adhesion prevents the material from delaminating from the substrate and cracking. The surface morphology of the Acheson Electrodag PF 427 Antimony Tin Oxide (ATO) ink is improved by the invention because the carbon nanotube conductive ink is used to bridge the larger particles found in the commercially available conductive ink. This bridging action by the carbon nanotube ropes also improves the ductility of the coating by allowing the ropes to be the focus point of the bending and thereby creating a virtual hinge between the carbon nanotubes and any traditional brittle conductive materials used in the coating. The commercially available conductive ink or a formulated ink with similar properties can then be applied in a thinner layer, and the carbon nanotubes layer creates the conductive connections to achieve similar or better conductivity with improved surface morphology and is significantly more ductile than traditional coatings formed from high solid content coatings. Because the amount of the larger particle solids to achieve the conductivity is reduced and therefore the conductive ink approaches a mono layer of the larger particles bridged by the significantly smaller carbon nanotubes the final cured conductive coating or ink is both ductile and has improved surface morphology. The curing is achieved by application of heat over time. Suitable curing can be achieved by exposing the coating to 50-120 degrees C. for 5 to 30 minutes. The carbon nanotube and solvent mixture also helps the adhesion of the coating to the substrate thereby improving the resistance to mechanical damage and cracking when the strip electrode is bent. The increase in ductility and adhesion are related because with strong adhesion and good ductility the coating or ink does not crack and the adhesion prevents the material from delaminating from the substrate and cracking.

A preferred novel application of the invention involves the application of the either the Acheson Electrodag PF 427 Antimony Tin Oxide (ATO) ink by diluting it with a solvent and applying it to a substrate. This creates a coating that has significantly smoother surface morphology and is more ductile than the screen printable ink sold; however, the conductivity is greatly reduced. To overcome this problem additional layers of the carbon nanotube ink are applied over the first layer so as to enhance the conductivity. This second application also further improves the surface morphology of the coated substrate that provides an improved surface for electrochemistry and helps create a ductile film that can be formed by mechanical means into the contact for attaching the strip to a meter. An example of this formulation is Electrodag PF427 diluted with o-xylene and acetone. The resulting dispersion is mixed. Then a dispersion of carbon nanotubes is applied to the substrate by spraying. The dispersion of carbon nanotubes is made from single wall or multi wall carbon nanotubes preferably sized to be less than 20 nm and greater than 0.5 nm in outer dimension size suspended in a solvent. The modified coating of the invention is applied and cured for 20 minutes at 90 degrees Celsius. However, suitable curing is achieved by application of heat over time and curing has been achieved by exposing the coating to 50-120 degrees C. for 5 to 30 minutes.

In a preferred embodiment the carbon nanotubes are mixed uniformly into the Acheson Electrodag 427 such that the percent by weight is between 0.5 to 10%. Preferably the carbon nanotubes are added such that they make up 10% by weight of the mixture. Additionally platinum nano particles can be added and mixed uniformly to the coating or ink such that the percent by weight is between 0.5 to 10%. A nano particle is a particle of material that is less than 100 nano meters in diameter and is formed from a metal, metal oxide, organic conductive material or conventional conductive particles such as conductive inorganic materials. The conductive organic materials may comprise particles containing fullerenes, spherical fullerenes (buckyballs), carbon black, graphite fibers, graphite particles, or combinations and mixtures thereof. Conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, amorphous carbon, or combinations or mixtures thereof. Preferred conductive materials include, but are not limited to, tin-indium mixed oxide, antimony-tin mixed oxide, fluorine-doped tin oxide, aluminum-doped zinc oxide and combinations. An alternative embodiment is to add a catalyst to the coating or ink. The catalyst can be added directly to the coating or ink or it can be functionalized to the carbon nanotubes by chemically adhering the metal to the carbon nanotube by plating or other chemical process. Preferably the nano size platinum particles are added such that they make up less than 4% by weight of the mixture. The resulting coating or ink thicknesses when applied to a substrate are between about 0.5 nm to about 1000 microns and the adhesion to the substrate that they are applied is increased over the initial commercial dispersion which allows for mechanical forming of the electrode because it is also ductile. The increase in ductility and adhesion are related because with strong adhesion and good ductility the coating or ink does not crack and the adhesion prevents the material from delaminating from the substrate and cracking. This is seen when a 1 mm stainless steel flat edge implement is used to scratch using 100 grams of force against the surface of each material. The Acheson Electrodag is applied per the suppliers' specifications. The modified dispersion of the invention is applied and cured for 20 minutes at 90 degrees Celsius. The Acheson Electrodag coating is removed leaving the uncoated substrate whereas the coating of the invention is still attached to the substrate. However, suitable curing is achieved by application of heat over time and curing has been achieved by exposing the coating to 50-120 degrees C. for 5 to 30 minutes.

Any of the coatings or inks made from the dispersion of the invention also results in improved electrical conductivity with surface resistance in the range of less than approximately 10⁶ ohms/square per 1 mm square area. This allows the electrons generated from the reaction to be transferred unheeded so that the reaction can be measured by either coulometry, amperometry, or potentiometry. Accordingly, in a preferred embodiment, the conductive coating or ink has a surface resistance in the range of less than about 10,000 ohms/square per 1 mm square area. Preferably, the conductive ink or coating has a surface resistance in the range of about 10-10,000 ohms/square per 1 mm square area. Preferably, the conductive ink or coating has a surface resistance in the range of about 100-10,000 ohms/square per 1 mm square area. Preferably, the conductive coating or ink has a surface resistance in the range of less than about 1000 ohms/square per 1 mm square area. Preferably, the conductive ink or coating has a surface resistance in the range of less than about 100 ohms/square per 1 mm square area. Preferably, the conductive ink or coating has a surface resistance in the range of about 10-100 ohms/square per 1 mm square area.

The conductive inks and coatings also have volume resistances, as defined in ASTM D4496-87 and ASTM D257-99, in the range of about 100 ohms-cm to 10×10⁶ ohms-cm.

As discussed above, the present invention utilizes conductive materials and manufacturing techniques to provide electrochemical test devices.

In a preferred embodiment of the invention, the conductive coating and inks created from the dispersions provide coatings that are ductile and have a smooth surface morphology, are ductile and have good adhesion to the substrate they are applied to and they are comprised of nanotubes, metal oxides, carbon, organic conductive compounds, inorganic conductive compounds and metals.

Other objects, features and advantages of the present invention will become apparent from the following detailed description. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The accompanying drawings, which are incorporated and constitute a part of the specification, illustrate preferred embodiments of the invention and, together with the general description given above and the detailed description of the preferred embodiments given below, serve to explain the principles of the invention. Thus, for a more complete understanding of the present invention, the objects and advantages thereof, reference is now made to the following descriptions taken in connection with the accompanying figures in which:

FIG. 1 illustrates a view of the working electrode of the test strip of the invention and conductive materials coating surface with the proximal end bent up so the coated surface face up.

FIG. 2 illustrates a view of the counter electrode of the test strip of the invention and conductive materials coating surface with the proximal end bent down so the coated surface face up.

FIG. 3 illustrates a view of the adhesive tape spacer.

FIG. 4 illustrates a view of the assembled test strip of the invention.

FIG. 5 is a drawing of a test strip of the invention showing the use of the ductile coating to form the contacts for test system.

FIG. 6 is a graph of the abrasion resistance of the material of the invention.

FIG. 7 is a graph of the folding resistance of the material of the invention.

FIG. 8 is an alternate configuration of the test strip of the invention with holes to provide access to the contacts for test system.

FIG. 9 is an SEM showing the carbon nanotubes bonds from between the larger conductive particles

### DESCRIPTION OF THE INVENTION

As used herein, the following definitions define the stated term:

“Amperometry” includes steady-state amperometry, chronoamperometry, and Cottrell-type measurements.

A “biological fluid” is any body fluid in which the analyte can be measured, for example, blood (which includes whole blood and its cell-free components, such as, plasma and serum), interstitial fluid, dermal fluid, sweat, tears, urine and saliva.

“Coulometry” is the determination of charge passed or projected to pass during complete or nearly complete electrolysis of the analyte, either directly on the electrode or through one or more electron transfer agents. The charge is determined by measurement of charge passed during partial or nearly complete electrolysis of the analyte or, more often, by multiple measurements during the electrolysis of a decaying current and elapsed time. The decaying current results from the decline in the concentration of the electrolyzed species caused by the electrolysis.

A “counter electrode” refers to one or more electrodes paired with the working electrode, through which passes an electrochemical current equal in magnitude and opposite in sign to the current passed through the working electrode. The term “counter electrode” is meant to include counter electrodes which also function as reference electrodes (i.e. a counter/reference electrode) unless the description provides that a “counter electrode” excludes a reference or counter/reference electrode.

An “electrochemical sensor” is a device configured to detect the presence of and/or measure the concentration of an analyte via electrochemical oxidation and reduction reactions. These reactions are transduced to an electrical signal that can be correlated to an amount or concentration of analyte.

The term “facing electrodes” refers to a configuration of the working and counter electrodes in which the working surface of the working electrode is disposed in approximate opposition to a surface of the counter electrode. In at least some instances, the distance between the working and counter electrodes is less than the width of the working surface of the working electrode.

A compound is “immobilized” on a surface when it is entrapped on or chemically bound to the surface.

A “layer” is one or more layers.

The “measurement zone” is defined herein as a region of the sample chamber sized to contain only that portion of the sample that is to be interrogated during an analyte assay.

A “redox mediator” is an electron transfer agent for carrying electrons between the analyte and the working electrode, either directly, or via a second electron transfer agent.

A “reference electrode” includes a reference electrode that also functions as a counter electrode (i.e., a counter/reference electrode) unless the description provides that a “reference electrode” excludes a counter/reference electrode.

A “surface in the sample chamber” is a surface of a working electrode, counter electrode, counter/reference electrode, reference electrode, indicator electrode, a spacer, or any other surface bounding the sample chamber.

A “working electrode” is an electrode at which analyte is electrooxidized or electroreduced with or without the agency of a redox mediator.

A “working surface” is the portion of a working electrode that is covered with non-leachable redox mediator and exposed to the sample, or, if the redox mediator is diffusible, a “working surface” is the portion of the working electrode that is exposed to the sample.

A “base surface morphology” is the surface morphology of the substrate that the coating is applied to. This forms the base surface morphology which when polyester is used as the substrate can be as low as 80 nm from high to low points on the substrate. Therefore the total surface roughness for an application on polyester could be 2580 nm when accounting for the initial roughness of the polyester substrate.

A nano particle is a particle of material that is less than 100 nano meters in diameter and is formed from a metal, metal oxide, organic conductive material or conventional conductive particles such as conductive inorganic materials. The conductive organic materials may comprise particles containing fullerenes, spherical fullerenes (buckyballs), carbon black, graphite fibers, graphite particles, or combinations and mixtures thereof. Conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, amorphous carbon, or combinations or mixtures thereof. Preferred conductive materials include, but are not limited to, tin-indium mixed oxide, antimony-tin mixed oxide, fluorine-doped tin oxide, aluminum-doped zinc oxide and combinations.

A “carbon nanotube rope” is formed from two or more carbon nanotubes that knit together to form string or rope structure to connect two or more conductive particles or mass of carbon nanotubes. The rope structure can also be multiple carbon nanotube formed into a bundle and two or more bundles attached so as to form a rope structure.

The small volume, in vitro analyte sensors of the present invention are designed to measure the concentration of an analyte in a portion of a sample having a volume no more than about 1 micro. L, preferably no more than about 0.5 micro. L, preferably no more than about 0.3 micro. L, still more preferably no more than about 0.25 micro. L, and most preferably no more than about 0.1 micro. L of sample.

The analyte of interest is typically provided in a solution or biological fluid, such as blood or serum.

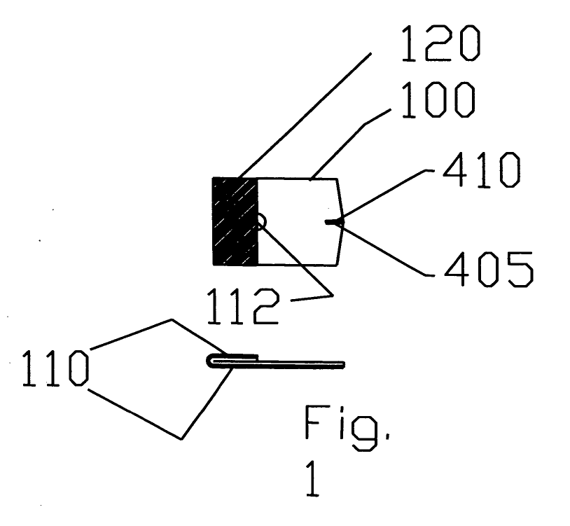

FIG. 1 illustrates a view of the working electrode 100 of the test strip of the invention and conductive materials 110 coating surface with the proximal end bent up so the coated surface face up. The ability to bend the electrode so that the electrode can be coated on one side without patterning and the working electrode 100 to form a lead 120 for interfacing with the test device is formed from the same surface but bent so as to be facing the opposite direction as the sensing surface. This eliminates the expensive patterning printing processes. The ductile conductive coating 110 is formed from a dispersion of conductive materials including carbon nanotubes so that vent 112 is clear to allow air flow. The coatings of the invention are especially suited for use with electrochemical applications where a smooth surface morphology, ductility and high bond strength provides improved the performance characteristics of the test strip. The invention selectively uses dispersions in the formulation of inks formed from carbon nanotubes with a particular diameter less than 20 nm. The resulting conductive inks and coatings provide excellent conductivity, ductile films and have very smooth surface morphologies and can be patterned very repeatable by using stencils or screen printing methods as well as other traditional printing processes. However, when applied to a substrate and cured the inks and coatings of the invention form ductile coatings that have a high bond strength to the substrate which can be formed by bending which is not possible with the brittle coatings formed from conductive inks and coatings disclosed in the prior art. Suitable curing is achieved by application of heat over time and curing has been achieved by exposing the coating to 50-120 degrees C. for 5 to 30 minutes.

The improved surface morphologies of dispersions of the invention form conductive inks and coatings with surface morphology roughness less than 2500 nano meters when compared to the surface roughness of the base substrate which is significantly smoother than current printed ink technologies which are designed as dispersions of finely divided graphite, silver or silver chloride particles in a thermoplastic resin and contain solids in the range of 20% to 60%. The particles used in current conductive coatings tend to be at least 100 microns to 10 microns in diameter and result in a surface roughness in the 1-2 micron range and the large particles cause the electrodes formed from these inks to be brittle and therefore not bendable. When test devices are formed but the dry vacuum process the crystalline nature of the resulting coating is also brittle and cannot be bent. The carbon nanotube conductive inks formed from dispersions of the invention and having of the same conductive capacity have solids contents of 2-3% and the particle size is less than 20 nanometers for the carbon nanotubes portion of the dispersion. Compared to conventional inks, this is 500 times smaller than the 10 micron particle, the surface roughness is 10 times smoother and the solid content is between 6 and 20 times less. The surface morphology of the conductive binders and inks used such as Acheson Electrodag PF 427 (an Antimony Tin Oxide (ATO) ink) is improved by the invention because the carbon nanotube conductive ink is used to bridge the larger particles found in the commercially available conductive ink. The commercially available conductive ink or a formulated ink with similar properties can then be applied in a thinner layer and the carbon nanotubes layer creates the conductive connections to achieve similar or better conductivity with improved surface morphology because the amount of the larger particle solids to achieve the conductivity is reduced and therefore the conductive ink approaches a mono layer of the larger particles bridged by the significantly smaller carbon nanotubes. This results in strong bonded ink that is ductile and can be bent. Therefore in a novel application of the invention involves the application of conductive polymer based ink in a thin film such as Acheson Electrodag PF 427 Antimony Tin Oxide (ATO) ink by diluting it with a solvent and applying it to a substrate, the ink can also be formed from various conductive and nonconductive solids, solvents and polymers. The polymer which can be used to form a conductive ink can be selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, Poly(methlmethacrylate), polynucleotides and mixtures thereof, or ceramic hybrid polymers, Ethylene Glycol Monobutl Ether Acetate, phosphine oxides and chalcogenides. The conductive materials which can be added to the form the conductive dispersion can be selected from tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, amorphous carbon, silver, platinum or a doped oxide layer, or a hard coat such as a silicon coat. Dispersions of the invention may further comprise additional conductive organic materials, inorganic materials or combinations or mixtures of such materials. The conductive organic materials may comprise particles containing fullerenes, spherical fullerenes (buckyballs), carbon black, graphite fibers, graphite particles or nanotubes with an outer diameter of less than about 20 nm, and combinations and mixtures thereof. Conductive inorganic materials may comprise particles of aluminum, antimony, beryllium, cadmium, chromium, cobalt, copper, doped metal oxides, iron, gold, lead, manganese, magnesium, mercury, metal oxides, nickel, platinum, silver, steel, titanium, zinc, amorphous carbon, or combinations or mixtures thereof. Preferred conductive materials include tin-indium mixed oxide, antimony-tin mixed oxide, fluorine-doped tin oxide, aluminum-doped zinc oxide and combinations and/or mixtures thereof. Preferred dispersions may also contain fluids, gelatins, ionic compounds, semiconductors, solids, surfactants, and combinations or mixtures thereof.

The solvent is selected so that the carbon nanotubes can also form a high strength bond between the ink or coating and the substrate they are applied to. The carbon nanotube dispersion is formed by taking either single-wall nanotubes (SWNT), double-walled (DWNT) or multi-wall (MWNT) and dispersing them in a solvent. For this example the solvent is acetone. 20 mg of DWNT is placed in a vial and then 40 ml of acetone is added to the vial. Then the contents of the vial are mixed, using a SANYO MSE SONIPREP 150 tuned to 23 kH and using one-quarter power for 25 minutes.

Next modify 0.87 grams of Acheson Electrodag—PF 427 by adding 1000 micro liters of the acetone cnt dispersion and 500 micro liters of acetone. Sonicate using a SANYO MSE SONIPREP 150 tuned to 23 kH at high power for 10 min. so that it can be spray coated on onto 0.001 inch thick polyester panels. Prior to application, clean the panels with soap, rinse in pure water and allow drying. After the panels have dried, perform a second cleaning step with methanol and a lint free cloth and dry. After spray coating the PF-427 dispersion layer then spray coat the carbon nanotube dispersion from the first step over the PF 427 layer and cure for 1 min. at 95 degrees C. Repeat the application of carbon nanotubes and curing step six more times, forming a total of seven applications of carbon nanotube dispersion. Finally, cure the composite matrix by drying for 20 min. at 95 degrees C.; the permissible variation is 10 to 25 min. and 75-100 degrees C. The benefit of this process is that when using a diluted, more traditional conductive coating, the coating can be applied in a much thinner layer and the carbon nanotube dispersion applied to the top surface forms the interconnects between the larger conductive particles, transferring electrical and thermal energy more efficiently. The process allows the layers to be applied more thinly, facilitating a smoother surface morphology and providing higher lubricity due to the exposed particles integrating into a smoother surface morphology, creating a surface with significantly lower coefficient of friction. The carbon nanotube layers can be applied such that they create a layer with a thickness of less than 100 nm and the traditional conductive coating can be applied with a thickness between 1000 nm and 0.001 inches, thinner than traditionally applied and the composite results in conductivity equal to or greater than the traditional coating process while improving the surface morphology and coating adhesion to the substrate. This creates a coating that has significantly smoother surface morphology than the screen printable ink sold; however, the conductivity is greatly reduced because the large conductive particles are spread out so that they do not form dense conducting networks. To overcome this problem additional layers of the carbon nanotube ink are applied over the first layer so as to enhance the conductivity. This second application also further improves the surface morphology of the coated substrate that provides an improved surface for electrochemistry and helps create a ductile coating by using the carbon nanotube ropes formed by the carbon nanotubes to bridge the gaps between the larger conductive particles. The average surface morphology of sample working electrodes has been shown to be less than 2500 nm when compared to the substrate base surface morphology.

Another example of a suitable formulation is to take 0.87 grams of Electrodag PF427 is diluted with 1000 micro liters of o-xylene and 500 micro liters of acetone. The resulting dispersion is sonicated in an ultrasonic cleaner such as a VWR 50HT for 10 minutes. Then the dispersion is applied to the substrate by spraying to form a thin coating of the conductive materials. Then a dispersion of carbon nanotubes is applied on top of the first coating by spraying. The dispersion of carbon nanotubes is made from taking either single-wall nanotubes (SWNT), double-walled (DWNT) or multi-wall (MWNT) and dispersing them in a solvent. For this example the solvent is acetone. 20 mg of DWNT is placed in a vial and then 40 ml of acetone is added to the vial. Then the contents of the vial are mixed, using a SANYO MSE SONIPREP 150 tuned to 23 kH and using one-quarter power for 25 minutes preferably sized to be less than 20 nm and greater than 0.5 nm in outer dimension size suspended in a solvent. The modified coating of the invention is applied and cured for 20 minutes at 90 degrees Celsius. However, suitable curing is achieved by application of heat over time and curing has been achieved by exposing the coating to 50-120 degrees C. for 5 to 30 minutes. The carbon nano tube coating can also be alloyed with platinum, silver silver/chloride or other useable electrochemical material to create a working, counter or a reference electrode as required by the strip design.

After the working electrode has been formed a suitable chemistry 405 is applied to the measurement zone 410. The suitable chemistry will contain materials which form a coating on a wall of the measurement zone and can for example be an enzyme, an antigen or antibody. Among suitable examples are urease, glucose oxidase, concanavalin A or antiglobulin antibody. Especially in the case of enzyme coatings, the enzyme can be either immobilized or coated in releasable form.

Various types of analytical or electrochemical sensor reagents may be applied to the working surface of the electrode. These can be either represented by amperometry chemistry, coulometry chemistry, and the chemistries may be immobilized or contain a redox mediator. To create a functional electrochemical test device, a reagent chemistry must be selected based on the analyte to be tested and the desired detection limits. Preferably, the reagent is deposited on the measurement zone 410 such that a uniform amount is applied from sensor to sensor. The reagent may be applied using any conventional procedure, such as nozzle coating with an IVEK pump or any other drop on demand system capable of delivering consistent and uniform volume of reagent.

The reagent is applied to the working electrode's working surface, but may in some cases also be applied to another electrode. After the reagent has been applied, it is typically dried. Subsequently, when the test device is used, the test sample of aqueous fluid, such as blood, rehydrates the reagent and a potential is applied to the electrodes from which a current measurement may be taken by a meter that is connected via the bent leads 120 of the electrode and 220 of the counter electrode. The leads 120 and 220 are bent so that the electrodes form contacts for the electronic testing device such that the contact surface is a minimum of 91 degrees and a maximum of 360 degrees from the electrode working surface.

An example reagent formulation suitable for use in the present invention is described below. This reagent may be used to determine the presence or concentration of glucose in an aqueous fluid sample. Preferably, this reagent formulation is used with an electrochemical sensor having a counter electrode 200 and working electrode 100.

Reagent Formulation Amount/Material Concentration 2-(N-morpholino) ethanesulfonic acid (MES buffer) 100 millimolar (mM) Triton X-100 0.08% wt/wt Polyvinyl alcohol (PVA) mol. wt. 10K 88% 1.00% wt/wt hydrolyzed Imidazole osmium mediator, reduced, as defined in 6.2 mM U.S. Pat. No. 5,437,999 Glucose Oxidase 6000 units/mL

The above reagent formulation may be prepared using the following procedures: (a) 1.952 grams of MES buffer is added to 85 mL of nanograde water. The mixture is stirred until the components dissolve. The pH of the solution is adjusted to 5.5 with NaOH. The volume of the solution is then brought to 100 mL of final buffer solution. (b) 0.08 grams of Triton X-100 and 1 gram of PVA is added to a beaker capable of holding all the components (e.g., a 200 mL beaker). The buffer solution is added to bring the total solution weight to 100 grams. The mixture is heated to boiling and stirred to dissolve the PVA. (c) 4.0 mg of the reduced osmium mediator is added to 1 mL of the solution from step (b) above. The mixture is stirred to dissolve the mediator. (d) The mixture is left to cool to room temperature. (e) 6000 units of glucose oxidase are added and the mixture is mixed until the enzyme is dissolved.

The above reagent formulation may be used to determine the presence or concentration of glucose in an aqueous fluid sample. Other reagent formulations may be employed to assay different analytes. Such reagent formulations are designed to react specifically with the desired analyte to form a measurable electrochemical signal:

Without being limited to theory, it is believed that in the example reagent formulation described above, glucose is anaerobically oxidized or reduced with the involvement of the enzyme and the redox mediator. Such a system is sometimes referred to as an amperometric biosensor. In such a system, the current flowing is limited by mass transport. Therefore, the current is proportional to the bulk glucose concentration. The analyte, enzyme and mediator participate in a reaction where the mediator is either reduced (receives at least one electron) or oxidized (donates at least one electron). The glucose reaction ends when glucose oxidase is oxidized and the mediator is reduced. The mediator is then oxidized at the surface of the working electrode by the applied potential difference. Changes in the system amperage result from changes in the ratio of oxidized/reduced form of the redox mediator. The amperage change directly correlates to the detection or measurement of glucose in the test sample.

Various enzymes may be used in the reagent formulations employed in this invention. The particular enzyme employed will vary depending on the analyte to be detected or measured. Preferred enzymes include glucose oxidase, glucose dehydrogenase, cholesterol esterase and alcohol oxidase. The amount of enzyme employed will generally range from about 0.5 to about 3.0 million units of enzyme per liter of reagent formulation.

The reagent formulation will also typically contain a redox mediator. The rcdox mediator will generally be chosen to be compatible with the enzyme employed and combinations of redox mediators and enzymes are well known in the art. Suitable redox mediators include, by way of example, potassium ferricyanide and ferrocene derivatives, such as 1,1.cent.-dimethyl ferrocene. The amount of redox mediator employed in the reagent formulation will typically range from about 0.15M to about 0.7M. Additional mediators suitable for use in this invention include methylene blue, p-benzoquinone, thionine, 2,6-dichloroindophenol, gallocyanine, indophenol, polyviologen, osmium bis(2,2.cent.-bipyridine) dihydrochloride, and riboflavin-5.cent.-phosphate ester. Optionally, these mediators can be chemically bound or entrapped in a matrix, such as a polymer, using procedures well known in the art.

Examples of enzyme/mediator combinations suitable for use in this invention include, but are not limited to, the following: Analyte Enzyme Mediator glucose-glucose dehydrogenase ferricyanide glucose-glucose oxidase tetracyanoquinodimethane cholesterol-cholesterol esterase ferricyanide alcohol-alcohol oxidase phenylenediamine.

A preferred reagent chemistry uses potassium ferricyanide as a mediator.

In addition to an enzyme and a redox mediator, the reagent layer on the electrode preferably further comprises a buffer, a stabilizer, a dispersant, a thickener or a surfactant. These materials are typically employed in amounts which optimize the reaction of the reagents with the analyte. The concentration ranges for these components referred to below are for the reagent formulation before it has dried on the electrode surface.

A buffer is preferably employed in the reagent formulation to provide a satisfactory pH for enzyme function. The buffer used has a higher oxidation potential than the reduced form of the redox mediator. A preferred buffer for use in this invention is a phosphate buffer having a concentration ranging from about 0.1M to about 0.5M. Other suitable buffers include BES, BICINE, CAPS, EPPS, HEPES, MES, MOPS, PIPES, TAPS, TES and TRICINE buffers (collectively known as ‘GOOD’ buffers), citrate, TRIS buffer, and the like. The ‘GOOD’ and TRIS buffers are commercially available from Sigma-Aldrich, Inc. (St. Louis, Mo., U.S.A.).

A stabilizer may also be employed in the reagent formulation to stabilize the enzyme. When the enzyme used is glucose oxidase, a preferred stabilizer is potassium glutamate at a concentration ranging from about 0.01 to 4.0% weight. Other suitable stabilizers include succinate, aspartate, blue dextran and the like.

Additionally, dispersants may be used in the reagent formulation to enhance the dispersion of the redox mediator and to inhibit its recrystallisation. Suitable dispersants include microcrystalline cellulose, dextran, chitin and the like. Typically, the dispersant is used in the reagent formulation in an amount ranging from about 1.0 to about 4.5% weight. Preferred dispersants include, but are not limited to, AVICEL RC-591 (a microcrystalline cellulose available from FMC Corp.) and NATROSOL-250 M (a microcrystalline hydroxyethylcellulose available from Aqualon).

A thickener may also be employed in the reagent formulation to hold the reagent to the electrode surface. Suitable thickeners include water soluble polymers, such as polyvinylpyrrolidone.

Additionally, a surfactant may be added to the reagent formulation to facilitate rapid and total wetting of the electrode surface. Preferably, the reagent formulation contains a nonionic surfactant in an amount ranging from about 0.01 to 0.3% by weight. A preferred surfactant is TRITON X-100, available from Sigma-Aldrich, Inc.

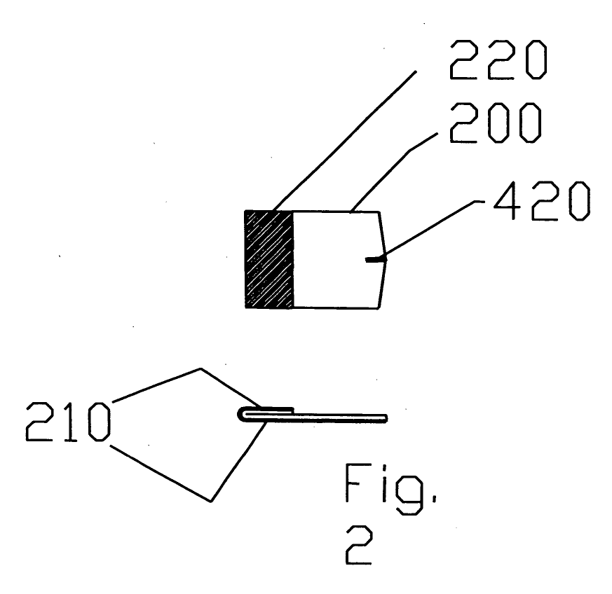

FIG. 2 illustrates a view of the counter electrode 200 of the test strip of the invention and conductive materials 210 coating surface with the proximal end bent down so the coated surface face up. The ability to bend the electrode so that it the electrode can be coated on one side without patterning and the counter electrode 200 to form a lead 220 for interfacing with the test device is formed from the same surface but bent so as to be facing the opposite direction as the sensing surface. This eliminates the expensive patterning printing processes. The ductile conductive coating 210 is formed from a dispersion of conductive materials including carbon nanotubes and nano size silver/silver chloride particles to create the counter electrode with a measurement zone 420. The improved surface morphologies of dispersions of the invention form conductive inks and coatings with surface morphology roughness less than 2500 nano meters when compared to the surface roughness of the base substrate which is significantly smoother than current printed ink technologies which are designed as dispersions of finely divided graphite, silver or silver chloride particles in a thermoplastic resin and contain solids in the range of 20% to 60%. The surface morphology of the substrate which the coating is applied to forms the base surface morphology which when polyester is used as the substrate can be as low as 80 nm from high to low points on the substrate. Therefore the total surface roughness for an application on polyester could be 2580 nm when accounting for the initial roughness of the polyester substrate. When comparing the surface roughness of the carbon nanotube based ink to a traditional conductive ink formed from 50 micron diameter particle material which has a surface roughness in the 50,000 nano meter range the 2500 nano meter surface roughness is significantly better. Therefore, surface morphology of the conductive binders such as Acheson Electrodag PF 427 Antimony Tin Oxide (ATO) ink is improved by the invention because the carbon nanotube conductive ink is used to bridge the larger particles found in the commercially available conductive ink and also creates a bridging method to integrate the and nano size silver/silver chloride particles. Therefore in a novel application of the invention involves the application of conductive polymer based ink in a thin film such as Acheson Electrodag PF 427 Antimony Tin Oxide (ATO) ink by diluting it with a solvent and applying it to a substrate, the ink can also be formed from various conductive and nonconductive solids, solvents and polymers. The polymer which can be used to form a conductive ink can be selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, Poly(methlmethacrylate), polynucleotides and mixtures thereof, or ceramic hybrid polymers, Ethylene Glycol Monobutl Ether Acetate, phosphine oxides and chalcogenides. The conductive materials which can be added to the form the conductive dispersion can be selected from tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, amorphous carbon, silver, platinum or a doped oxide layer, or a hard coat such as a silicon coat. Dispersions of the invention may further comprise additional conductive organic materials, inorganic materials or combinations or mixtures of such materials. The conductive organic materials may comprise particles containing fullerenes, spherical fullerenes (buckyballs), carbon black, graphite fibers, graphite particles or nanotubes with an outer diameter of less than about 20 nm, and combinations and mixtures thereof. Conductive inorganic materials may comprise particles of aluminum, antimony, beryllium, cadmium, chromium, cobalt, copper, doped-metal oxides, iron, gold, lead, manganese, magnesium, mercury, metal oxides, nickel, platinum, silver, steel, titanium, zinc, amorphous carbon, or combinations or mixtures thereof. Preferred conductive materials include tin-indium mixed oxide, antimony-tin mixed oxide, fluorine-doped tin oxide, aluminum-doped zinc oxide and combinations and/or mixtures thereof. Preferred dispersions may also contain fluids, gelatins, ionic compounds, semiconductors, solids, surfactants, and combinations or mixtures thereof. The solvent is selected so that the carbon nanotubes can also form a high strength bond between the ink or coating and the substrate they are applied to. The carbon nanotube dispersion is formed by taking either single-wall nanotubes (SWNT), double-walled (DWNT) or multi-wall (MWNT) and dispersing them in a solvent. For this-example the solvent is acetone. The first step is to take 10 mg of silver powder from Sigma Aldrich, 2-3.5 μm, 99.9+ pure and 10 mg of silver chloride powder from sigma Aldrich 227927 and place in a ball mill and mill for one hour. Then take 20 mg of DWNT is placed in a vial. Then 20 mg of silver silver/chloride powder that has been milled is added to the vial and then 40 ml of acetone is added to the vial. Then the contents of the vial are mixed, using a SANYO MSE SONIPREP 150 tuned to 23 kH and using one-quarter power for 25 minutes. Next modify 0.87 grams of Acheson Electrodag-PF 427 by adding 1500 micro liters of acetone. Sonicate using a SANYO MSE SONIPREP 150 tuned to 23 kH at high power for 10 min. so that it can be spray coated on onto 0.001 inch thick polyester panels. Prior to application, clean the panels with soap, rinse in pure water and allow drying. After the panels have dried, perform a second cleaning step with methanol and a lint free cloth and dry. After spray coating the PF-427 dispersion layer then spray coat the carbon nanotube and silver silver/chloride dispersion from the first step over the PF 427 layer and cure for 1 min. at 95 degrees C. Repeat the application of carbon nanotubes and silver silver/chloride and curing step six more times, forming a total of seven applications of carbon nanotube and silver silver/chloride dispersion. Finally, cure the composite matrix by drying for 20 min. at 95 degrees C.; the permissible variation is 10 to 25 min. and 75-100 degrees C. The benefit of this process is that when using a diluted, more traditional conductive coating, the coating can be applied in a much thinner layer and the carbon nanotube dispersion applied to the top surface forms the interconnects between the larger conductive particles, transferring electrical and thermal energy more efficiently. The process allows the layers to be applied more thinly, facilitating a smoother surface morphology and providing higher lubricity due to the exposed particles integrating into a smoother surface morphology, creating a surface with significantly lower coefficient of friction. The carbon nanotube and silver silver/chloride layers can be applied such that they create a layer with a thickness of less than 100 nm and the traditional conductive coating can be applied with a thickness between 1000 nm and 0.001 inches, thinner than traditionally applied and the composite results in conductivity equal to or greater than the traditional coating process while improving the surface morphology and coating adhesion to the substrate. This creates a coating that has significantly smoother surface morphology than the screen printable ink sold; however, the conductivity is greatly reduced because the large conductive particles are spread out so that they do not form dense conducting networks. To overcome this problem additional layers of the carbon nanotube ink are applied over the first layer so as to enhance the conductivity. This second application also further improves the surface morphology of the coated substrate that provides an improved surface for electrochemistry and helps create a ductile coating by using the carbon nanotube ropes formed by the carbon nanotubes to bridge the gaps between the larger conductive particles. The average surface morphology of sample working electrodes has been shown to be less than 2500 nm when compared to the existing surface morphology of the substrate base surface roughness.

The leads 120 and 220 are bent so that the electrodes form contacts for the electronic testing device such that the contact surface is a minimum of 91 degrees and a maximum of 360 degrees from the electrode working surface.

The carbon nano tube coating can also be alloyed with platinum, silver silver/chloride or other useable electrochemical material to create either a working, counter or a reference electrode as required by the strip design.

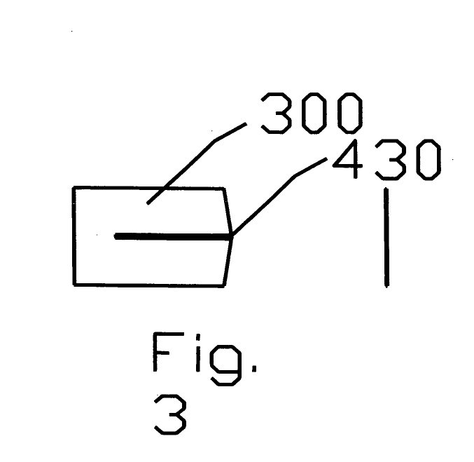

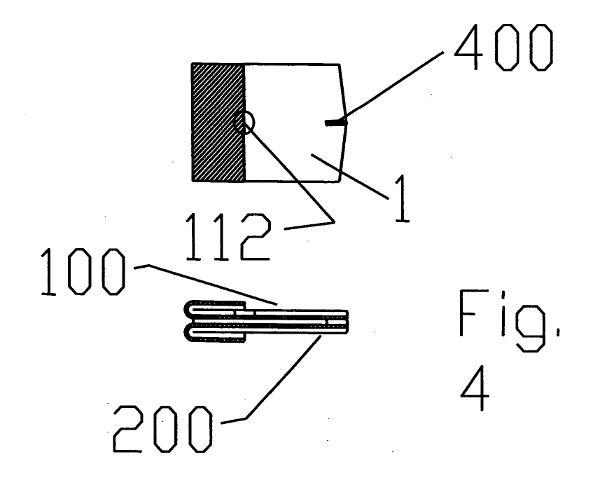

FIG. 3 illustrates a view of the adhesive tape spacer 300. The adhesive spacer is designed to attach the working electrode 100 to the counter electrode 200 so as to form a measurement zone 430 shown in FIG. 4 which is the space between 410 and 420.

FIG. 4 illustrates a view of the assembled test strip 1 of the invention which shows the reaction area 400 made up of measurement zone components 410, 420 and 430.

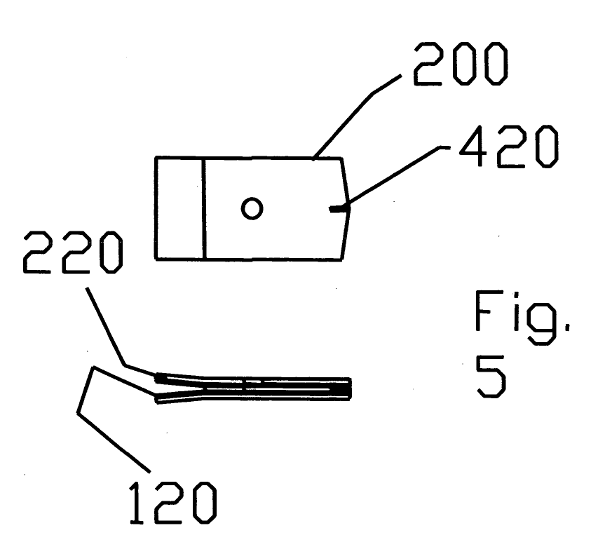

FIG. 5 is a drawing of a test strip of the invention showing the use of the ductile coating to form the contacts 120 and 220 for test system. The leads 120 and 220 are bent so that the electrodes form contacts for the electronic testing device such that the contact surface is the minimum of 181 degrees of the maximum of 360 degrees from the electrode working surface.

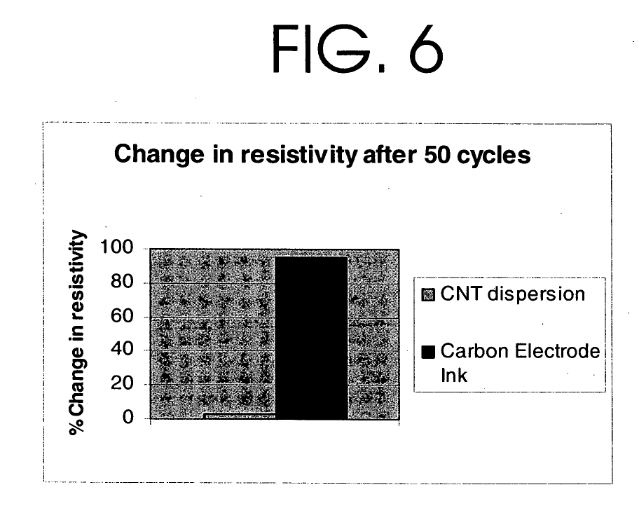

FIG. 6 is a graph of the abrasion resistance of the material of the invention. The abrasion test was performed by taking a one pound weight and wrapping it in a linen cloth. Then sliding it back and forth on the material. 1 cycle=2 passes across surface. Change in resistance was measured after 50 cycles. The abrasion resistance is important for the conductive coating so that the contacts form for test system from the conductive coating does not get mechanically removed when the test strip of the invention is inserted in the test system to complete the measurement circuit.

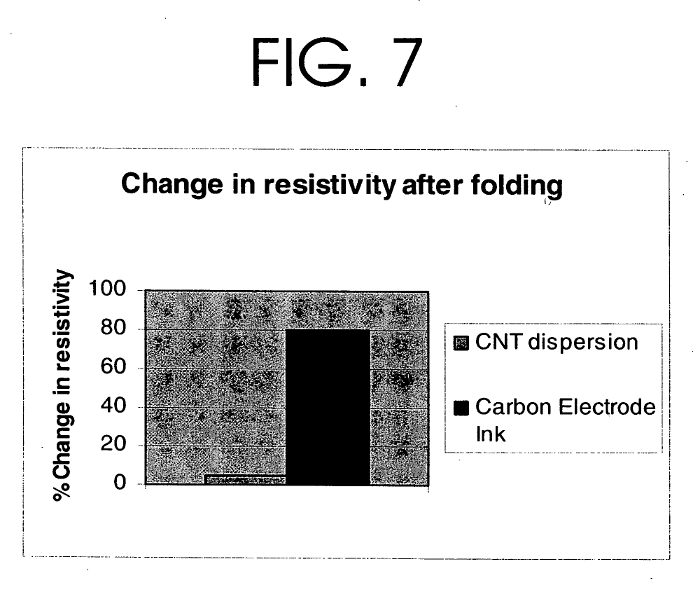

FIG. 7 is a graph of the folding resistance of the material of the invention. A 4 kilogram weight was dropped on a piece of the material folded so that the conductive coating was facing inward. The fold caused the sheet to be bent. The weight is dropped on PET side of sample 2X, creating “fold”. Change in resistance was measured after unfolding. Buy folding and then unfolding the coated surface the ductility of the coating is demonstrated.

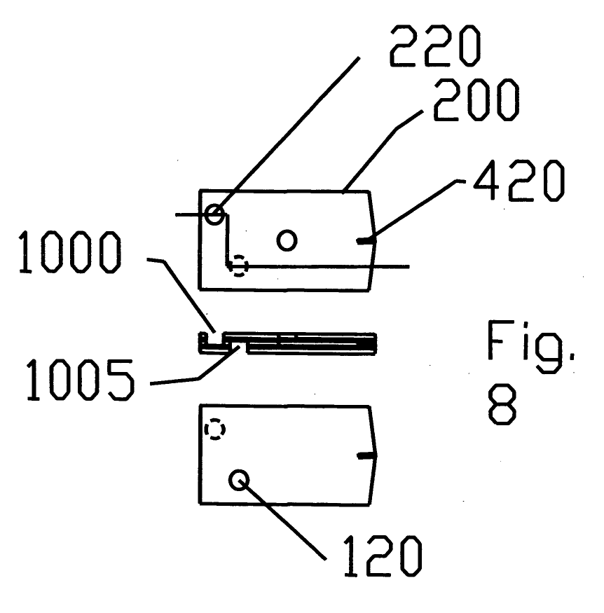

FIG. 8 shows a version of the test strip where access holes 1000 and 1005 have been die cut to allow access to the contacts 120 and 220 for test system. The leads 120 and 220 are exposed by the holes punched in the opposing electrodes so that the electrodes form contacts for the electronic testing device.

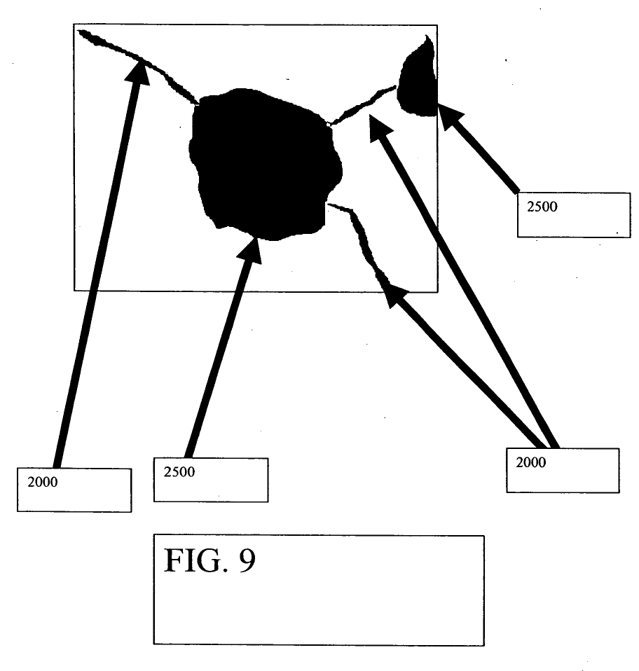

FIG. 9 shows an SEM image of a conductive film of the invention showing the bonds formed from carbon nanotube ropes 2000 between the larger conductive particles 2500 of the Acheson Electrodag PF 427 Antimony Tin Oxide (ATO) ink used in the dispersion of the invention. A “carbon nanotube rope” is formed from two or more carbon nanotubes that knit together to form string or rope structure to connect two or more conductive particles or mass of carbon nanotubes. The rope structure can also be multiple carbon nanotube formed into a bundle and two or more bundles attached so as to form a rope structure.

A third electrode or reference electrode could be incorporated into the counter electrode film by applying the reference electrode and the counter electrode so that the two electrodes form measurement zone 420.

Any of the aforementioned coatings or inks made from the dispersion of the invention result in improved electrical conductivity with surface resistance in the range of less than approximately 10⁶ ohms/square per 1 mm square area. This allows the electrons generated from the reaction to be transferred unheeded so that the reaction can be measured by either coulometry, amperometry, or potentiometry. Accordingly, in a preferred embodiment, the conductive coating or ink has a surface resistance in the range of less than about 10,000 ohms/square per 1 mm square area. Preferably, the conductive ink or coating has a surface resistance in the range of about 10-10,000 ohms/square per 1 mm square area. Preferably, the conductive ink or coating has a surface resistance in the range of about 100-10,000 ohms/square per 1 mm square area. Preferably, the conductive coating or ink has a surface resistance in the range of less than about 1000 ohms/square per 1 mm square area. Preferably, the conductive ink or coating has a surface resistance in the range of less than about 100 ohms/square per 1 mm square area. Preferably, the conductive ink or coating has a surface resistance in the range of about 10-100 ohms/square per 1 mm square area.

The conductive inks and coatings also have volume resistances, as defined in ASTM D4496-87 and ASTM D257-99, in the range of about 100 ohms-cm to 10×10⁶ ohms-cm.

The present invention, thus generally described, will be understood more readily by reference to the following examples, which are provided by way of illustration and are not intended to be limiting of the present invention.

Although only a few exemplary enbodiments of the present invention have been described in detail in this disclosure, those skilled in the art who review this disclosure will readily appreciate that many modifications are possible in the exemplary embodiments (such as variations in sizes, structures, shapes and proportions of the various elements, values of parameters, or use of materials) without materially departing from the novel teachings and advantages of the invention. Accordingly, all such modifications are intended to be included within the scope of the invention as defined in the appended claims.

Other substitutions, modifications, changes and omissions may be made in the design, operating conditions and arrangement of the preferred embodiments without departing from the scope of the invention as expressed in the appended claims.

Additional advantages, features and modifications will readily occur to those skilled in the art. Therefore, the invention in its broader aspects is not limited to the specific details, and representative devices, shown and described herein. Accordingly, various modifications may be made without departing from the scope of the general inventive concept as defined by the appended claims and their equivalents.

All references cited herein, including all U.S. and foreign patents and patent applications, all priorily documents, all publications, and all citations to government and other information sources, are specifically and entirely hereby incorporated herein by reference. It is intended that the specification and examples be considered exemplary only, with the true scope of the invention indicated by the following claims.

As used herein and in the following claims, articles such as “the”, “a” and “an” can connote the singular or plural.

What is claimed is:

1. An electrochemical cell formed from a wet dispersion where the solvent is selected from chloroform, acetone, water, o-Xylene, o-Dichlorobenzene or alcohols and is dispersed in a coating or ink comprising of a plurality of carbon nanotubes with an outer diameter of less than 20 nm, said carbon nanotubes consisting of less than 10 percent by weight of the wet dispersion which is applied to a substrate as the wet dispersion and cured using heat so that the resulting cured coating or ink is conductive, ductile and has a surface morphology of less than about 2500 nm when compared to a base surface morphology.

2. An electrochemical cell of claim 1 wherein the wet dispersion comprises carbon nanotubes forming a carbon nanotube rope which comprises two or more carbon nanotubes that knit together to form string structure to connect two or more conductive particles or mass of carbon nanotubes when the dispersion is applied to a substrate and cured.

3. An electrochemical cell of claim 1 formed from a dispersion of carbon nanotubes, and other conductive particles, said other conductive particles being selected from the group consisting of metals, metal oxide, organic conductive material and inorganic materials, wherein said organic conductive material is selected from the group consisting of fullerenes, spherical fullerenes (buckyballs), carbon black, graphite fibers, graphite particles, and combinations and mixtures thereof, wherein the conductive inorganic material is selected from aluminum, antimony, beryllium, cadmium, chromium, cobalt, copper, doped metal oxides, iron, gold, lead, manganese, magnesium, mercury, metal oxides, nickel, platinum, silver, steel, titanium, zinc, zinc oxide, amorphous carbon, tin-indium mixed oxide, antimony-tin mixed oxide, fluorine-doped tin oxide, aluminum-doped zinc oxide or combinations or mixtures thereof, that uses the carbon nanotube ropes formed by in the inks and coatings to create a ductile film.

4. An electrochemical cell of claim 1 formed from a wet dispersion, wherein said nanotubes and other nano particles have an outer diameter of about 0.5 to 20 nm.

5. An electrochemical cell of claim 1, wherein said dispersion used to form the ink or coating is formed from a conductive carbon nanotubes which includes as part of the formulation carbon nanotubes, carbon nanotubes/antimony tin oxide, carbon nanotubes/platinum, carbon nanotubes/silver, carbon nanotubes/silver-chloride, amorphous carbon, carbon nanotubes and platinum carbon nanotubes/carbon, carbon nanotubes/platinum or carbon nanotubes/metals, combinations amorphous carbon, silver, silver/chloride, platinum, and their oxides.

6. An electrochemical cell of claim 1, wherein said carbon nanotubes are selected from the group consisting of single-walled nanotubes, double-walled nanotubes, multi-walled nanotubes, and mixtures thereof.

7. An electrochemical cell of claim 1, wherein said dispersion when applied to a substrate and cured has a differential surface morphology less than 2500 nm when compared to the base material surface morphology.

8. An electrochemical cell of claim 1, wherein said carbon nanotubes are present in said dispersion at about 0.001 to about 10% based on weight.

9. An electrochemical cell of claim 1, wherein said carbon nanotubes are present in said dispersion at about 0.05%.

10. An electrochemical cell of claim 1, wherein the dispersion has a surface resistance in the range of less than about 10.0×10¹⁰ ohms/square per 1 mm square area after it is applied to a substrate and cured.

11. An electrochemical cell of claim 1, wherein the coated material is bent in at least a 30 degrees so as to form the electrode and the contact for interfacing with an electrical measurement device.

12. An electrochemical cell of claim 1, made from a dispersion of carbon nanotubes and other conductive materials wherein the dispersion results in a coating or ink that has a surface roughness between 20 and 2500 nm after it is applied to a substrate and cured.

13. An electrochemical cell of claim 1, wherein the dispersion applied to form the electrode has a surface resistance in the range of less than about 10.0×10⁶ ohms/square per 1 mm square area after it is applied to a substrate and cured.

14. An electrochemical cell of claim 1, wherein the dispersion applied to form the electrode has a volume resistance in the range of about 10.0×10¹ ohms-cm to about 10.0×10¹⁰ ohms-cm after it is applied to a substrate and cured.

15. An electrochemical cell of claim 1, wherein the dispersion applied to form the electrode, where at least one component is a solvent selected from either acetone, water, ethers, o-Xylene, O-Dichlorobenzene and alcohols.

16. An electrochemical cell of claim 1, wherein the dispersion applied to form the electrode, further comprising a polymeric material, wherein the polymeric material comprises a material selected from the group consisting of thermoplastics, thermosetting polymers, elastomers, conducting polymers and combinations thereof.

17. An electrochemical cell of claim 1, wherein the working electrode form contacts for the electronic testing device such that the contact surface is a minimum of 91 degrees from the electrode working surface.

18. An electrochemical cell of claim 1, wherein the counter electrode form contacts for the electronic testing device such that the contact surface is a minimum of 91 degrees from the electrode working surface.

19. An electrochemical cell of claim 1, wherein the working electrode form contacts for the electronic testing device such that the contact surface is a minimum of 1 degrees and a maximum of 91 degrees from the electrode working surface.

20. An electrochemical cell of claim 1, wherein the counter electrode form contacts for the electronic testing device such that the contact surface is a minimum of 1 degrees and a maximum of 91 degrees from the electrode working surface.

21. An electrochemical cell of claim 1, wherein the working electrode form contacts for the electronic testing device such that the contact surface is exposed but parallel to second electrode working surface.

22. An electrochemical cell of claim 1, wherein the counter electrode form contacts for the electronic testing device such that the contact surface is exposed but parallel to second electrode working surface.
